(19) United States
(12) Patent Application Publication
(10) Pub. No.: US 2025/0091040 A1
(43) Pub. Date: Mar. 20, 2025

(54) PREPARATION METHOD FOR NI AND MN BIMETALLIC ELECTROCATALYST AND ITS APPLICATION IN SMALL MOLECULE ELECTROOXIDATION

(71) Applicant: Beijing University of Chemical Technology, Beijing (CN)

(72) Inventors: Jieshan QIU, Beijing (CN); Jun QI, Beijing (CN); Qi YANG, Beijing (CN)

(73) Assignee: Beijing University of Chemical Technology, Beijing (CN)

(21) Appl. No.: 18/829,233

(22) Filed: Sep. 9, 2024

(30) Foreign Application Priority Data
Sep. 14, 2023 (CN) 202311185021.0

(51) Int. Cl. B01J 31/16; B01J 35/33; B01J 35/50; B01J 37/02; B01J 37/10; C25B 3/07; C25B 3/23; C25B 11/031; C25B 11/061; C25B 11/085

(52) U.S. Cl. CPC B01J 31/1691; B01J 35/33; B01J 35/50; B01J 37/0203; B01J 37/0207; B01J 37/0209; B01J 37/10; C25B 3/07; C25B 3/23; C25B 11/031; C25B 11/061; C25B 11/085; B01J 2531/0208; B01J 2531/72; B01J 2531/847; B01J 2531/985

(57) ABSTRACT

A preparation method for Ni and Mn bimetallic electrocatalyst and its application in small molecule electrooxidation are provided. The method includes the following steps: cleaning a matrix to remove a surface oxide layer; dissolving nickel salt, manganese salt, terephthalic acid, salicylic acid, and urea into a mixed solution of ethanol, DMF, and water and transferring to a hydrothermal reaction kettle together with the treated matrix for a hydrothermal reaction; then, obtaining a NiMn-MOF/NF precursor by cooling, cleaning, and drying. Dissolving and stirring sodium borohydride and selenium powder and transferring the above solution to the hydrothermal reaction kettle for hydrothermal selenization reaction with NiMn-MOF/NF; then, obtaining a self-supporting NiMn-MOF-Se catalyst with uniform nanosheet structure by cooling and cleaning. The catalyst synthesis method is simple and controllable, with low cost, uniform catalyst morphology, and good conductivity, it can be directly used as an electrode.

### CROSS REFERENCE TO THE RELATED APPLICATIONS

This application is based upon and claims priority to Chinese Patent Application No. 202311185021.0, filed on Sep. 14, 2023, the entire contents of which are incorporated herein by reference.

### TECHNICAL FIELD

The present invention belongs to the field of electrocatalysis, and specifically relates to a preparation method for Ni and Mn bimetallic electrocatalyst and its application in small molecule electrooxidation.

### BACKGROUND

With the development of clean and renewable energy sources such as wind energy and solar energy, the conversion of small molecules driven by electricity has ushered in new development opportunities, especially the technology of hydrogen production from electrolytic water and the electrochemical synthesis technology of fine chemicals. The reduction of fossil energy reserves and the resulting environmental pollution have endowed hydrogen energy as a green and clean energy, strong development vitality, and with the maturity and large-scale development of technology, the use of hydrogen energy is expected to achieve low carbon emissions throughout the life cycle and promote the realization of the dual carbon goal.

Hydrogen production from electrolytic water is restricted by electricity consumption, which is at a disadvantage in cost compared with hydrogen production from fossil energy, reducing the power consumption of hydrogen production from electrolytic water is the key to its large-scale application. The anodic oxygen evolution reaction accounts for more than 90% of the energy consumption of hydrogen production from electrolytic water, and the economic value of the product oxygen is low, which is a bottleneck problem to be solved urgently in the hydrogen production technology of electrolytic water. As an alternative technology for oxygen evolution reaction, small molecule oxidation reaction provides an effective strategy for reducing the energy consumption of hydrogen production from electrolytic water. The oxidation potential of small molecule alcohols represented by methanol and glycerol is lower than that of the oxygen evolution reaction, which has an obvious energy-saving effect at the same hydrogen production rate, meanwhile, the electrochemical upgrading of small molecule chemicals can increase the added value and reduce the cost of the whole hydrogen production process, in addition, it can effectively avoid the contact between hydrogen and oxygen in conventional electrolytic water, and improve the safety and operation cycle of the device.

The development of catalysts with high catalytic activity, high product selectivity, good stability, and low cost is the key to the electrocatalytic oxidation coupled with hydrogen production of small organic molecules, and it is also an important way to reduce the cost of hydrogen production from electrolytic water. CN114086202A has disclosed a non-noble metal catalyst for glycerol oxidation-assisted hydrogen production. The Co₃O₄ material grown on nickel foam was obtained by hydrothermal method and high-temperature calcination, the catalyst achieved a current density of 10 mA/cm² at a voltage of 1.22 V, the above research shows that many of the currently disclosed catalysts have problems such as low catalytic activity and poor selectivity, especially, the catalytic activity and stability under industrial current density requirements are difficult to meet the actual needs, and most of the catalysts are difficult to prepare on a large scale, therefore, it is of great significance to develop low-cost catalysts with high activity and selectivity for small molecule electrooxidation.

### SUMMARY

In order to overcome the shortcomings of the existing technology, the present invention provides a preparation method for Ni and Mn bimetallic electrocatalyst and its application in small molecule electrooxidation, which has the advantages of simple and controllable synthesis process, low raw material cost, high catalytic activity and selectivity, and large-scale preparation, and is expected to provide an excellent catalyst for the industrial development of electrocatalytic small molecule oxidation coupled with green hydrogen production.

In order to realize the above present invention objective and solve the problems existing in the existing technology, the technical scheme adopted by the present invention is:
a preparation method for Ni and Mn bimetallic electrocatalyst, comprising the following steps:
(1) cleaning a matrix to remove a surface oxide layer, and obtaining a treated matrix;
(2) dissolving nickel salt, manganese salt, terephthalic acid, salicylic acid and urea into a mixed solution and transferring to a high-pressure hydrothermal reaction kettle together with the treated matrix for a hydrothermal reaction; then, obtaining a NiMn-MOF precursor by cooling, cleaning and drying;
a molar ratio of nickel salt to manganese salt is (0.5:1)-(2:1), and a molar ratio of terephthalic acid to metal salt is (1:8)-(1:2); the mixed solution is a mixture of ethanol, N, N-dimethylformamide and water;
(3) dissolving sodium borohydride and selenium powder into deionized water, and stirring continuously for 0.5-2 h in a nitrogen atmosphere; then transferring the above solution to the high-pressure hydrothermal reaction kettle, meanwhile adding NiMn-MOF precursor to carry out a hydrothermal selenization reaction, then, obtaining a self-supporting NiMn-MOF-Se catalyst with uniform nanosheet structure by cooling and cleaning; a mass ratio of sodium borohydride and selenium powder is (1:1)-(1:4).

The matrix is nickel foam, copper foam or carbon fiber paper; preferably nickel foam matrix.

Step (1) cleaning the matrix with hydrochloric acid, ethanol and water in turn.

A volume ratio of ethanol, N, N-dimethylformamide and water in the mixture is 1:3:2.

In step (2), a temperature of the hydrothermal reaction is 120-160° C. and a reaction time is 6-24 h.

In step (3), a temperature of the hydrothermal selenization reaction is 120-160° C. and the reaction time is 6-24 h.

The nickel salt is nickel nitrate, nickel acetate, nickel chloride or nickel sulfate; the manganese salt is manganese sulfate, manganese nitrate or manganese chloride.

The NiMn-MOF-Se catalyst is applied to electrochemical oxidation of small molecule alcohol chemicals.

The NiMn-MOF-Se catalyst is applied to electrochemical oxidation of methanol, ethylene glycol or glycerol.

Commercially purchased nickel foam matrix can be replaced with copper foam or carbon fiber paper.

A ratio of ethanol, N, N-dimethylformamide and water is 1:3:2 to ensure the full dissolution of terephthalic acid.

A ratio of sodium borohydride and selenium powder is (1:1)-(1:4), it is necessary to wait for the selenium powder to fully react with sodium borohydride when stirring in a nitrogen atmosphere, and the color of the solution becomes clear.

The prepared Ni and Mn bimetallic electrocatalysts can be applied to an electrochemical oxidation of small molecular chemicals such as methanol, ethylene glycol, and glycerol.

Further, the specific steps are:

step 1) cutting the nickel foam matrix into 2*4 cm², ultrasonically cleaning with 1-3 mol/L hydrochloric acid for 30 min, and then repeatedly rinsing with ethanol and water.

step 2) ultrasonically dissolving 1 mmol Ni(NO₃)₂·6H₂O, 1 mmol MnCl₂·4H₂O, 0.5 mmol terephthalic acid, 0.2 g salicylic acid and 0.3 g urea into the mixed solution of ethanol, N, N-dimethylformamide and water, and transferring the above solution to the hydrothermal reactor kettle together with the treated nickel foam matrix and keeping at 150° C. for 12 h. After cooling, washing with deionized water and ethanol, and drying in an oven at 60° C. overnight to obtain the NiMn-MOF/NF catalyst precursor.

step 3) weighing and dissolving 0.1 g sodium borohydride and 0.16 g selenium powder into deionized water and stirring continuously for 30 min under the nitrogen atmosphere, when the solution begins to change from black to colorless, transferring the above solution to the hydrothermal reaction kettle, meanwhile, adding the NiMn-MOF/NF catalyst precursor obtained from step 2, and carrying out the hydrothermal selenization reaction at 140° C. for 8 h; after cooling, washing with deionized water and ethanol, and drying in the oven at 60° C. overnight to obtain the self-supporting NiMn-MOF-Se/NF catalyst with uniform nanosheet structure.

Study on a performance of electrocatalytic small molecule oxidation. In the standard three-electrode electrolytic cell system, the NiMn-MOF-Se/NF catalyst is directly used as a working electrode, Hg/HgO and carbon rod are used as a reference electrode and a counter electrode, respectively, an electrolyte is 1 M KOH and an appropriate concentration of organic small molecule substrate (such as 0.5 mol/L methanol), all electrochemical performance tests are performed using a Chenhua 760E electrochemical workstation, CV electrochemical activation is required before the test, and a voltage range is set to −0.2-0.6 V (vs. Hg/HgO), a scanning rate is 10 mV/s, and a number of scanning cycles are 40 cycles, the LSV polarization curve is tested after the CV scanning curve is stable, and parameter settings comprise: a potential range is −0.2 V-0.6 V (vs. Hg/HgO), the scanning rate is 10 mV/s, and the iR compensation is set to 85%. In addition to the polarization curve, a Faraday efficiency of the oxidation product needs to be quantitatively analyzed, an electrolyte running for 2 h under different voltages is obtained by a transverse potential method, and the quantitative analysis is carried out by ¹H NMR, the Faraday efficiency of the target product is calculated according to the amount of transferred charge, finally, a multiple charge-time curve is obtained by a potentiostatic method, and the stability of the catalyst is evaluated.

The advantages of the present invention are as follows: the preparation method is simple and controllable, the raw material is non-noble metal, the cost is low, large-scale preparation, and the uniformity of catalyst morphology is easy to realize. In terms of application, the synthesized NiMn-MOF-Se catalyst has excellent catalytic activity for small molecule alcohols (methanol, glycerol, ethylene glycol, etc.), and thus shows significant energy-saving potential in the coupled hydrogen production industry, and can realize the conversion of low-value chemicals to high-value-added chemicals.

The introduction of high-valent metals and the hybridization of non-metallic elements are conducive to regulating the electronic structure of the active center, which can improve the catalytic activity and selectivity. In addition, as a self-supporting electrode, it does not require the use of adhesiveness, so it has excellent electron transport capacity and small interface resistance, and the rich pore structure and good hydrophilicity provided by the nanoarray also promote the exposure of active sites and the penetration of electrolyte, the NiMn-MOF-Se/NF catalyst synthesized by the present invention has excellent catalytic activity and selectivity for the electrooxidation of small molecules such as methanol, the industrial current density of 400 mA cm⁻² can be achieved at only 1.42 V (vs. RHE), and the selectivity of formic acid products is more than 95%, which can meet the commercial requirements and provide a reliable catalyst for the development of electrochemical synthesis coupled with green hydrogen preparation system.

### BRIEF DESCRIPTION OF THE DRAWINGS

FIG. 1 is an SEM image of NiMn-MOF-Se/NF catalyst in embodiment 1.

FIG. 2 is an XRD pattern of NiMn-MOF-Se/NF catalyst in embodiment 1.

FIG. 3 is LSV curves of methanol electrooxidation by precursors with different ratios of Ni and Mn in embodiment 3.

FIG. 4 is an LSV curve of methanol electrooxidation by NiMn-MOF-Se/NF catalyst in embodiment 9.

### DETAILED DESCRIPTION OF THE EMBODIMENTS

The following is a further explanation of the present invention in combination with embodiments. The following non-restrictive implementation measures can enable ordinary technicians in this field to understand the present invention more comprehensively, but do not limit the present invention in any way.

Unless otherwise specified, the experimental methods described in the following examples are conventional; unless otherwise specified, reagents and materials are all commercially available.

### Embodiment 1

The preparation methods for Ni and Mn bimetallic electrocatalysts for small molecule electrooxidation are as follows:

step 1) the nickel foam matrix is cut into 2*4 cm², ultrasonically cleaned with 2 mol/L hydrochloric acid for 30 min, and then repeatedly rinsed with ethanol and water to remove the surface oxide layer.

Step 2) 1 mmol Ni(NO₃)₂·6H₂O, 1 mmol MnCl₂·4H₂O, 0.5 mmol terephthalic acid, 0.2 g salicylic acid and 0.3 g urea are ultrasonically dissolved into a mixed solution containing 5 mL ethanol, 15 mL N, N-dimethylformamide and 10 mL water, and transferred the above solution to a high-pressure hydrothermal reactor kettle together with the treated nickel foam matrix and kept at 150° C. for 12 h. After cooling, the nickel foam grown with nanocatalysts is washed with deionized water and ethanol, and dried in an oven overnight to obtain the NiMn-MOF/NF catalyst precursor.

Step 3) 0.1 g sodium borohydride and 0.2 g selenium powder are weighed and dissolved into deionized water and stirred continuously for 30 min under a nitrogen atmosphere, when the solution begins to change from black to colorless, transferred the above solution to the high-pressure hydrothermal reaction kettle, meanwhile, the NiMn-MOF/NF catalyst precursor obtained from step 2 is added, and the hydrothermal selenization reaction is carried out at 140° C. for 8 h; after cooling, washed and dried overnight to obtain a self-supporting NiMn-MOF-Se/NF catalyst with uniform nanosheet structure.

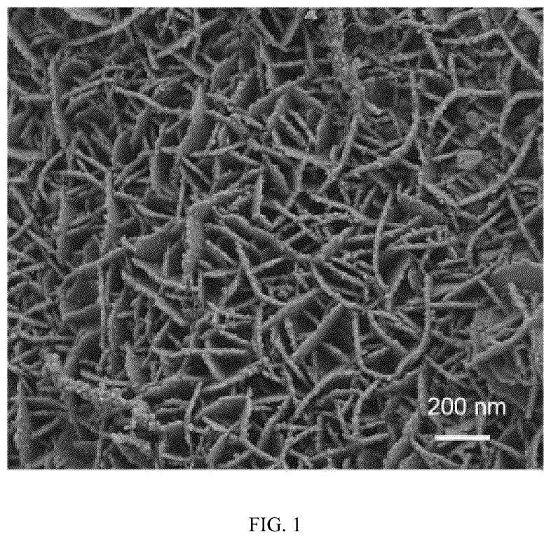

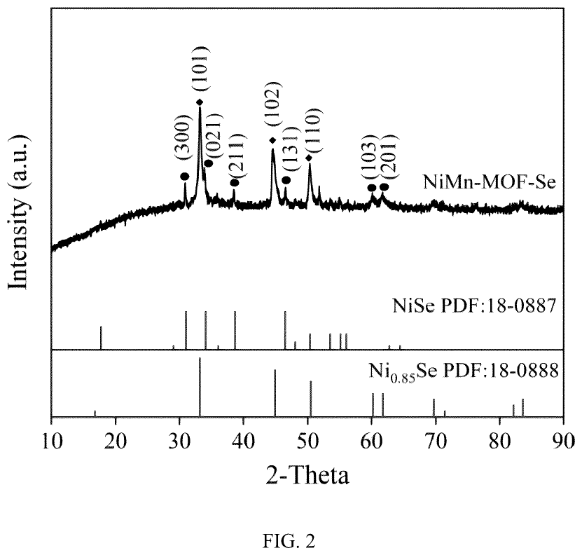

The morphology of the material is characterized by scanning electron microscopy (SEM), the results showed that the NiMn-MOF-Se/NF catalyst has a uniform nanosheet structure and grows on the skeleton of the nickel foam matrix (FIG. 1), then the crystal structure of the NiMn-MOF-Se/NF catalyst is characterized by XRD (FIG. 2), the characteristic peaks matched the (300), (021), (211), (131), (103), (201) crystal planes of NiSe (PDF: 18-0887) and the (101), (102), (110), crystal planes of Ni_{0.85}Se (PDF: 18-0888), wherein Mn is doped into the NiSe crystal structure by lattice doping.

### Embodiment 2

The preparation method for Ni and Mn bimetallic electrocatalysts for small molecule electrooxidation mentions a replaceable matrix, which can also achieve good results, here, copper foam and carbon paper are selected as the research matrix, as follows:

step 1) the copper foam and carbon paper are cut into 2*4 cm², ultrasonically cleaned with 2 mol/L hydrochloric acid for 30 min, and then repeatedly rinsed with ethanol and water.

Step 2) 1 mmol Ni(NO₃)₂·6H₂O, 1 mmol MnCl₂·4H₂O, 0.5 mmol terephthalic acid, 0.2 g salicylic acid and 0.3 g urea are ultrasonically dissolved into a mixed solution containing 5 mL ethanol, 15 mL N, N-dimethylformamide and 10 mL water, and transferred the above solution to a high-pressure hydrothermal reactor kettle together with the treated copper foam or carbon paper and kept at 150° C. for 12 h. After cooling, washed and dried to obtain the NiMn-MOF/NF catalyst precursor.

Step 3) 0.1 g sodium borohydride and 0.16 g selenium powder are weighed and dissolved into deionized water and stirred continuously for 30 min under a nitrogen atmosphere, then transferred the above solution to the high-pressure hydrothermal reaction kettle, meanwhile, the NiMn-MOF/NF catalyst precursor obtained from step 2 is added, and the hydrothermal selenization reaction is carried out at 140° C. for 8 h; after cooling, washed and dried, and dried in an oven at 60° C. overnight to obtain a self-supporting NiMn-MOF-Se/NF catalyst.

From the perspective of morphology, the change of the matrix to carbon fiber paper or copper foam has little effect on the morphology of the catalyst, and it still exhibits a uniform nanoarray structure, the catalytic performance of the two catalysts is further evaluated by electrochemical tests in the same way, compared with nickel foam as the matrix, the performance of the two catalysts is reduced, wherein, the performance of the catalyst based on copper foam is relatively excellent, slightly inferior to that of the NiMn-MOF-Se/NF catalyst, however, the catalyst based on carbon paper is restricted by the conductivity and charge transfer ability of carbon paper itself, and the performance reduction is relatively obvious, the anode potential of 1.5 V-1.6 V (vs. RHE) is required to achieve an industrial current density of 400 mA cm⁻².

### Embodiment 3

In the preparation method for Ni and Mn bimetallic electrocatalysts for small molecule electrooxidation, the ratio of Ni and Mn precursors is adjustable, and the corresponding research is carried out:

step 1) the nickel foam matrix is cut into 2*4 cm², ultrasonically cleaned with 2 mol/L hydrochloric acid for 30 min, and then repeatedly rinsed with ethanol and water.

Step 2) 1 mmol Ni(NO₃)₂·6H₂O, 1 mmol MnCl₂·4H₂O, 0.5 mmol terephthalic acid, 0.2 g salicylic acid and 0.3 g urea are ultrasonically dissolved into a mixed solution containing 5 mL ethanol, 15 mL N, N-dimethylformamide and 10 mL water, in addition, two solutions with different Ni and Mn ratios are prepared, one containing 2 mmol Ni(NO₃)₂·6H₂O and 1 mmol MnCl₂·4H₂O, and the other containing 1 mmol Ni(NO₃)₂·6H₂O and 2 mmol MnCl₂·4H₂O, the added amount of other chemicals is same, after being fully stirred and dissolved, and transferred the above solution to a high-pressure hydrothermal reactor kettle together with the treated nickel foam matrix and kept at 150° C. for 12 h. After cooling, washed and dried to obtain the the three catalysts Ni₁Mn₂-MOF/NF, Ni₁Mn₁-MOF/NF and Ni₂Mn₁-MOF/NF.

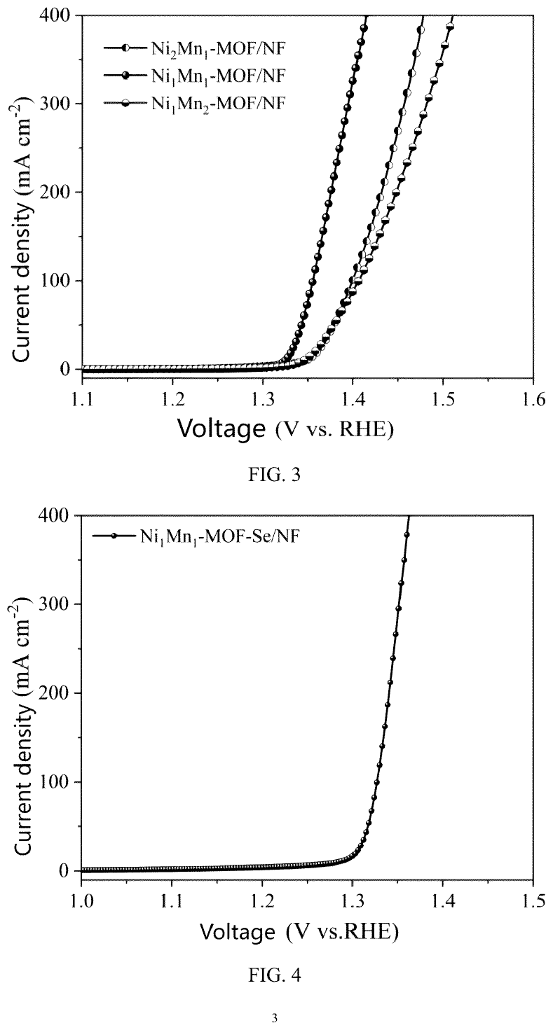

In the standard three-electrode electrolytic cell system, the above three catalysts are directly used as working electrodes, Hg/HgO and carbon rod are used as a reference electrode and a counter electrode, respectively, and an electrolyte is 1 mol/L KOH and 0.5 mol/L methanol, all electrochemical performance tests are performed using a Chenhua 760E electrochemical workstation, the result shows that the three precursor catalysts exhibited different catalytic activities for methanol oxidation, wherein, Ni₁Mn₁-MOF/NF has the best catalytic performance, and the industrial current density of 400 mA cm² could be achieved at an electrode potential of 1.42 V(vs. RHE) (FIG. 3), while the other two required 1.48 V and 1.53 V, respectively.

### Embodiment 4

In the preparation method for Ni and Mn bimetallic electrocatalysts for small molecule electrooxidation mentions that the molar ratio of terephthalic acid to metal precursor is (1:8)-(1:2), and the corresponding research is carried out:

step 1) the nickel foam matrix is cut into 2*4 cm², ultrasonically cleaned with 2 mol/L hydrochloric acid for 30 min, and then repeatedly rinsed with ethanol and water.

Step 2) 1 mmol Ni(NO₃)₂·6H₂O, 1 mmol MnCl₂·4H₂O, 0.5 mmol terephthalic acid, 0.2 g salicylic acid and 0.3 g urea are ultrasonically dissolved into a mixed solution containing 5 mL ethanol, 15 mL N, N-dimethylformamide and 10 mL water, in addition, two sets of mixed solutions containing 0.25 mmol and 1 mmol terephthalic acid are prepared, and transferred the above solution to a high-pressure hydrothermal reactor kettle together with the treated nickel foam matrix and kept at 150° C. for 12 h. After cooling, washed and dried to obtain the NiMn-MOF/NF catalyst precursor with different terephthalic acid contents.

Step 3) 0.1 g sodium borohydride and 0.16 g selenium powder are weighed and dissolved into deionized water and stirred continuously for 30 min under a nitrogen atmosphere, then transferred the above solution to the high-pressure hydrothermal reaction kettle, meanwhile, the three NiMn-MOF/NF catalyst precursor obtained from step 2 is added, and the hydrothermal selenization reaction is carried out at 140° C. for 8 h; after cooling, washed and dried overnight to obtain a self-supporting NiMn-MOF-Se/NF catalyst.

During the dissolution process of the mixture in step 2, it is found that the solubility of the mixed solution to terephthalic acid is limited, and the excess terephthalic acid is difficult to completely dissolve, according to the results of scanning electron microscopy, it is found that the morphology of the catalyst is slightly different, but not very obvious, therefore, the ratio of terephthalic acid to metal precursor is 1:4 is most suitable.

### Embodiment 5

In the preparation method for Ni and Mn bimetallic electrocatalysts for small molecule electrooxidation mentions that the hydrothermal reaction temperature in step 2 is 120-160° C., and the corresponding research is carried out:

step 1) the nickel foam matrix is cut into 2*4 cm², ultrasonically cleaned with 2 mol/L hydrochloric acid for 30 min, and then repeatedly rinsed with ethanol and water to remove the surface oxide layer.

Step 2) 1 mmol Ni(NO₃)₂·6H₂O, 1 mmol MnCl₂·4H₂O, 0.5 mmol terephthalic acid, 0.2 g salicylic acid and 0.3 g urea are ultrasonically dissolved into a mixed solution containing 5 mL ethanol, 15 mL N, N-dimethylformamide and 10 mL water, then transferred the above solution to a high-pressure hydrothermal reactor kettle together with the treated nickel foam matrix and kept at 120° C., 130° C., 140° C., 150° C. and 160° C. for 12 h, respectively. After cooling, washed and dried to obtain the NiMn-MOF/NF catalyst precursor.

Step 3) 0.1 g sodium borohydride and 0.16 g selenium powder are weighed and dissolved into deionized water and stirred continuously for 30 min under a nitrogen atmosphere, then transferred the above solution to the high-pressure hydrothermal reaction kettle, meanwhile, the three NiMn-MOF/NF catalyst precursor obtained from step 2 is added, and the hydrothermal selenization reaction is carried out at 140° C. for 8 h; after cooling, washed and dried overnight to obtain a self-supporting NiMn-MOF-Se/NF catalyst.

In terms of morphology, the temperature of the hydrothermal reaction in step 2 has an effect on the synthesis of the catalyst, with the increase of the reaction temperature, the structure of the nanoarray is more uniform, and there is little difference at 140° C., 150° C. and 160° C., and in terms of catalytic activity, the catalysts synthesized at each temperature show excellent catalytic performance, especially at the temperatures of 150° C. and 160° C., with the best performance.

### Embodiment 6

In the preparation method for Ni and Mn bimetallic electrocatalysts for small molecule electrooxidation mentions that the hydrothermal reaction time in step 2 is 6-24 h, and the corresponding research is carried out:

step 1) the nickel foam matrix is cut into 2*4 cm², ultrasonically cleaned with 2 mol/L hydrochloric acid for 30 min, and then repeatedly rinsed with ethanol and water.

Step 2) 1 mmol Ni(NO₃)₂·6H₂O, 1 mmol MnCl₂·4H₂O, 0.5 mmol terephthalic acid, 0.2 g salicylic acid and 0.3 g urea are ultrasonically dissolved into a mixed solution containing 5 mL ethanol, 15 mL N, N-dimethylformamide and 10 mL water, then transferred the above solution to a high-pressure hydrothermal reactor kettle together with the treated nickel foam matrix and the temperature kept at 120° C. for 6 h, 8 h, 12 h, 18 h and 24 h, respectively. After cooling, washed and dried to obtain the NiMn-MOF/NF catalyst precursor.

Step 3) 0.1 g sodium borohydride and 0.16 g selenium powder are weighed and dissolved into deionized water and stirred continuously for 30 min under a nitrogen atmosphere, then transferred the above solution to the high-pressure hydrothermal reaction kettle, meanwhile, the three NiMn-MOF/NF catalyst precursor obtained from step 2 is added, and the hydrothermal selenization reaction is carried out at 140° C. for 8 h; after cooling, washed and dried overnight to obtain a self-supporting NiMn-MOF-Se/NF catalyst.

In terms of morphology, the hydrothermal reaction time in step 2 has little effect on the catalyst, but in terms of catalytic activity, the catalyst prepared by 8 h and 12 h can already show the expected catalytic performance.

### Embodiment 7

In the preparation method for Ni and Mn bimetallic electrocatalysts for small molecule electrooxidation mentions that the ratio of sodium borohydride to selenium powder in step 3 is (1:1)-(1:4), and the corresponding research is carried out:

step 1) the nickel foam matrix is cut into 2*4 cm², ultrasonically cleaned with 2 mol/L hydrochloric acid for 30 min, and then repeatedly rinsed with ethanol and water.

Step 2) 1 mmol Ni(NO₃)₂·6H₂O, 1 mmol MnCl₂·4H₂O, 0.5 mmol terephthalic acid, 0.2 g salicylic acid and 0.3 g urea are ultrasonically dissolved into a mixed solution containing 5 mL ethanol, 15 mL N, N-dimethylformamide and 10 mL water, then transferred the above solution to a high-pressure hydrothermal reactor kettle together with the treated nickel foam matrix and the temperature kept at 120° C. for 12 h. After cooling, washed and dried to obtain the NiMn-MOF/NF catalyst precursor.

Step 3) different ratios of sodium borohydride and selenium powder (sample 1: 1.0 g sodium borohydride and 1.0 g selenium powder; sample 2: 1.0 g sodium borohydride and 2.0 g selenium powder; sample 3: 1.0 g sodium borohydride and 3.0 g selenium powder; sample 4: 1.0 g sodium borohydride and 4.0 g selenium powder) are weighed and dissolved into deionized water and stirred continuously under nitrogen atmosphere until the solution becomes clear, then transferred the above solution to the high-pressure hydrothermal reaction kettle, meanwhile, the three NiMn-MOF/NF catalyst precursor obtained from step 2 is added, and the hydrothermal selenization reaction is carried out at 140° C. for 8 h; after cooling, washed and dried overnight to obtain a self-supporting NiMn-MOF-Se/NF catalyst.

It is found that the content of sodium borohydride and selenium powder determines the progress of the reaction, when the content of selenium powder is low, excessive sodium borohydride will cause the reduction of metal in the catalyst, which will affect the morphology and performance, however, excessive selenium powder is difficult to be clear during the stirring process, but it will not affect the morphology and performance of the material and results in a waste of resources.

### Embodiment 8

In the preparation method for Ni and Mn bimetallic electrocatalysts for small molecule electrooxidation mentions that the hydrothermal temperature in step 3 is 120-160° C. and the reaction time is 6-24 h, and the corresponding research is carried out:

step 1) the nickel foam matrix is cut into 2*4 cm², ultrasonically cleaned with 2 mol/L hydrochloric acid for 30 min, and then rinsed with ethanol and water.

Step 2) 1 mmol Ni(NO₃)₂·6H₂O, 1 mmol MnCl₂·4H₂O, 0.5 mmol terephthalic acid, 0.2 g salicylic acid and 0.3 g urea are ultrasonically dissolved into a mixed solution containing 5 mL ethanol, 15 mL N, N-dimethylformamide and 10 mL water, then transferred the above solution to a high-pressure hydrothermal reactor kettle together with the treated nickel foam matrix and the temperature kept at 120° C. for 12 h. After cooling, washed and dried to obtain the NiMn-MOF/NF catalyst precursor.

Step 3) 0.1 g sodium borohydride and 0.2 g selenium powder are weighed and dissolved into deionized water and stirred continuously for 30 min under a nitrogen atmosphere, then transferred the above solution to the high-pressure hydrothermal reaction kettle, meanwhile, the three NiMn-MOF/NF catalyst precursor obtained from step 2 is added, and the hydrothermal selenization reaction is carried out at 140° C., 150° C. and 160° C. for 6 h, 12 h, 18 h and 24 h, respectively; after cooling, washed and dried overnight to obtain a self-supporting NiMn-MOF-Se/NF catalyst.

From the results, the hydrothermal reaction time and reaction temperature in step 3 have little effect on the catalyst, especially the reaction time, however, from the perspective of catalytic activity, increasing the reaction temperature is beneficial to the selenization process, and the catalytic activity is also improved.

### Embodiment 9

In the preparation method for Ni and Mn bimetallic electrocatalysts for small molecule electrooxidation mentions that the catalyst can be used for the electrochemical oxidation of small molecule chemicals such as methanol, ethylene glycol, glycerol, etc., and the corresponding exploration is carried out:

the NiMn-MOF-Se/NF catalyst is prepared by the method of embodiment 1, and then the electrochemical performance test is carried out under the same electrolysis conditions and electrolysis device, the difference is that the methanol in the electrolyte is replaced with 0.5 mol/L ethylene glycol and 0.5 mol/L glycerol. According to the results of polarization curves, the NiMn-MOF-Se/NF catalyst is universal for the electrochemical oxidation of various small molecules and exhibits excellent catalytic activity, the industrial current density of 400 mA cm⁻² can be achieved at the electrode potentials of 1.39 V and 1.40 V (vs. RHE) (FIG. 4), and the electrolysis products are all formic acid, and the Faraday efficiency is also more than 90%.

The preparation method for Ni and Mn bimetallic electrocatalyst discloses in the present invention is simple and controllable, the cost of non-noble metals is low, and it can be prepared on a large scale according to the requirements. In addition, it also shows attractive catalytic activity and selectivity, and the application prospect is promising, which has important economic value and practical value.

Although the implementation measures of the reference embodiment have shown and described the present invention in detail, ordinary technicians in this field should understand that without violating the spirit and scope of the present invention defined by the claim, various forms and details can be changed in it, and various implementation schemes can be combined.

What is claimed is:

1. A preparation method for a Ni and Mn bimetallic electrocatalyst, comprising the following steps:
(1) cleaning a matrix to remove a surface oxide layer, and obtaining a treated matrix;
(2) dissolving nickel salt, manganese salt, terephthalic acid, salicylic acid, and urea into a mixed solution and transferring to a high-pressure hydrothermal reaction kettle together with the treated matrix for a hydrothermal reaction, then, obtaining a NiMn-MOF precursor by cooling, cleaning, and drying;
a molar ratio of the nickel salt to the manganese salt is (0.5:1)-(2:1), and a molar ratio of the terephthalic acid to the nickel salt and the manganese salt is (1:8)-(1:2); the mixed solution is a mixture of ethanol, N, N-dimethylformamide, and water; and
(3) dissolving sodium borohydride and selenium powder into deionized water, and stirring continuously for 0.5-2 h in a nitrogen atmosphere to obtain a resulting solution; then transferring the resulting solution to the high-pressure hydrothermal reaction kettle, meanwhile adding the NiMn-MOF precursor to carry out a hydrothermal selenization reaction; then, obtaining a self-supporting NiMn-MOF-Se catalyst with a uniform nanosheet structure by cooling and cleaning; a mass ratio of the sodium borohydride and the selenium powder is (1:1)-(1:4).

2. The preparation method for the Ni and Mn bimetallic electrocatalyst according to claim 1, wherein the matrix is a nickel foam, a copper foam, or a carbon fiber paper.

3. The preparation method for the Ni and Mn bimetallic electrocatalyst according to claim 2, wherein the matrix is preferably a nickel foam matrix.

4. The preparation method for the Ni and Mn bimetallic electrocatalyst according to claim 1, wherein the step (1) comprises cleaning the matrix with hydrochloric acid, the ethanol, and the water in turn.

5. The preparation method for the Ni and Mn bimetallic electrocatalyst according to claim 1, a volume ratio of the ethanol, the N, N-dimethylformamide, and the water in the mixture is 1:3:2.

6. The preparation method for the Ni and Mn bimetallic electrocatalyst according to claim 1, wherein in the step (2), a temperature of the hydrothermal reaction is 120-160° C. and a reaction time is 6-24 h.

7. The preparation method for the Ni and Mn bimetallic electrocatalyst according to claim 1, wherein in step (3), a temperature of the hydrothermal selenization reaction is 120-160° C. and a reaction time is 6-24 h.

8. The preparation method for the Ni and Mn bimetallic electrocatalyst according to claim 1, wherein the nickel salt is nickel nitrate, nickel acetate, nickel chloride, or nickel sulfate; the manganese salt is manganese sulfate, manganese nitrate, or manganese chloride.

9. A method of using the self-supporting NiMn-MOF-Se catalyst prepared by the preparation method for the Ni and Mn bimetallic electrocatalyst according to claim 1, wherein the self-supporting NiMn-MOF-Se catalyst is applied to electrochemical oxidation of small molecule alcohol chemicals.

10. The method according to claim 9, wherein the small molecule alcohol chemicals are methanol, ethylene glycol, or glycerol.

11. The method according to claim 9, wherein in the preparation method, the matrix is a nickel foam, a copper foam, or a carbon fiber paper.

12. The method according to claim 11, wherein in the preparation method, the matrix is preferably a nickel foam matrix.

13. The method according to claim 9, wherein in the preparation method, the step (1) comprises cleaning the matrix with hydrochloric acid, the ethanol, and the water in turn.

14. The method according to claim 9, wherein in the preparation method, a volume ratio of the ethanol, the N, N-dimethylformamide, and the water in the mixture is 1:3:2.

15. The method according to claim 9, wherein in the step (2) of the preparation method, a temperature of the hydrothermal reaction is 120-160° C. and a reaction time is 6-24 h.

16. The method according to claim 9, wherein in the step (3) of the preparation method, a temperature of the hydrothermal selenization reaction is 120-160° C. and a reaction time is 6-24 h.

17. The method according to claim 9, wherein in the preparation method, the nickel salt is nickel nitrate, nickel acetate, nickel chloride, or nickel sulfate; the manganese salt is manganese sulfate, manganese nitrate, or manganese chloride.
